(19) United States
(12) Patent Application Publication
(10) Pub. No.: US 2006/0268305 A1
(43) Pub. Date: Nov. 30, 2006

(54) Image-Forming Device

(75) Inventor: Masatoshi Kadota, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi, Aichi-ken (JP)

(21) Appl. No.: 11/419,799

(22) Filed: May 23, 2006

(30) Foreign Application Priority Data
May 23, 2005 (JP) 2005149570

(51) Int. Cl. G06K 15/00; G06F 3/12

(52) U.S. Cl. 358/1.13; 358/1.16

(57) ABSTRACT

An image-forming device includes a connecting unit, a printing unit, an inputting unit, a script-processing unit and a controlling unit. The connecting unit is electrically connectable to an external storage device storing a printing condition setting script. The printing unit prints a recording medium. A user inputs printing condition information in the inputting unit. The script-processing unit reads the printing condition setting script stored in the external storage device, and processes the printing condition setting script based on the condition information to set a printing condition. The controlling unit controls the printing unit based on the printing condition.

### CROSS REFERENCE TO RELATED APPLICATIONS

This application claims priority to Japanese Patent Application No. 2005-149570 filed on May 23, 2005, the contents of which are hereby incorporated by reference into the present application.

### TECHNICAL FIELD

The present invention relates to an image-forming device, and a control program employed therein.

### BACKGROUND

There are printers well known in the art that print on a paper or other recording media based on printing conditions, print data, and the like received from a host device, such as a personal computer. This type of printer enables a user to perform a settings/functions confirmation print, such as a test print, through operations on the printer side for verifying that the printer is functioning properly.

Next, the settings/functions confirmation print will be described in detail. FIG. 1 is a block diagram showing the electrical configuration of a printer 10. The printer 10 includes a computer interface 19 for receiving data outputted from a host computer, a CPU 11, a RAM 12, a ROM 13, a printer engine 15, and a control panel 17. The control panel 17 is provided on a top surface of a casing configuring the printer 10. As shown in FIG. 2, the control panel 17 includes a liquid crystal display (LCD) 17A, and various touch keys including a SET key 17B, a BACK key 17C, a “+” key 17D, a “−” key 17E, and a cancel key 17F.

The ROM 13 is configured with a program storage area and a fixed data storage area. The RAM 12 is configured with a settings storage area. The program storage area stores an engine control program for driving the printer engine 15, and a confirmation printing process thread (program) for performing the settings/functions confirmation print. The fixed data storage area stores previously known numeral data, such as sizes of print papers. The settings storage area has a hierarchical structure (data tree), as shown in FIG. 3, and stores various data related to print settings and printing conditions.

When the operator performs an operation on the control panel 17 to indicate the settings/functions confirmation print, the CPU 11 executes the confirmation printing process thread according to the steps shown in the flowchart of FIG. 4 in order to perform the settings/functions confirmation print.

At the beginning of the process in S1, the CPU 11 reads the data tree of display messages shown in FIG. 3 and sets a pointer to point at the root shown in the drawing. When the SET key 17B is subsequently pressed, in S2 the CPU 11 displays the current status of the engine in the LCD 17A and prompts the user for the next input.

In S3 the CPU 11 determines whether the SET key 17B has been pressed. Once the user presses the SET key 17B (S3: YES), the CPU 11 shifts to the next lower hierarchical level in S4 by moving the pointer from the root to “Information.” In S5 the moved pointer is reflected in the LCD 17A. Next, the user performs directory operations with the four touch keys 17B-17E to execute a desired processing task.

Hence, to print the content of the print settings, the user presses the SET key 17B. In S7 the CPU 11 determines that the SET key 17B has been pressed and in S8 determines whether there is a lower hierarchical level than the current level indicated by the pointer. In this example, the current hierarchical level is the first level. Since there is a second hierarchical level below the first level (S8: YES), in S9 the CPU 11 moves the pointer to “Print setting” in the lower level.

Next, the CPU 11 returns to S5 and changes the display on the LCD 17A from “Information” to “Print setting.” If the SET key 17B is again pressed, the CPU 11 determines that there are no lower levels in the hierarchical structure (S8: NO) and in S10 executes the processing task. Since the processing task is “Print setting” in this case, the CPU 11 prints out data related to the print settings.

When the LCD 17A displays message “Print setting”, the user can press the “+” key 17D to select “Test print.” As a result, the CPU 11 determines that the “+” key 17D has been pressed (S11: YES), and in S12 changes the pointer from “Print setting” to “Test print.” As described above, when the SET key 17B is again pressed, the CPU 11 executes in S10 the process task, which is the “Test print” in this case.

In addition to possessing the settings/functions confirmation print function described above, conventional printers normally perform printing based on a print command received from a host device. However, standalone printers, such as that disclosed in Japanese unexamined patent application publication No. 2003-175657 can print on paper as a standalone unit without requiring a connection to a host device.

This standalone printer is provided with a memory card storing a plurality of printing conditions files for various paper sizes. The user can select a printing condition file corresponding to the paper size to be printed on the printer. Once the user has selected the printing condition file, the printer executes a program contained in the same file to perform the printing operation. Further, this type of program is a simplified program called a script that is convenient because it can be easily generated as a source program.

However, the printer described above merely lets the user select one of a plurality of scripts stored on a memory card that conforms to desired printing conditions. Accordingly, the number of patterns of printing conditions that the user can select is limited to the number of scripts pre-stored on the memory card.

Consequently, the above described printer is not practical because users may require a rich variety of printing conditions, making it necessary to provide a script for each variation of the printing conditions in order to meet this need.

### SUMMARY

In view of the foregoing, it is an objective of the present invention to provide an image-forming device having a simplified construction for providing a wide variety of printing conditions.

In order to attain the above and other objects, the present invention provides an image-forming device including a connecting unit, a printing unit, an inputting unit, a script-processing unit and a controlling unit. The connecting unit is electrically connectable to an external storage device storing a printing condition setting script. The printing unit prints a recording medium. A user inputs printing condition information in the inputting unit. The script-processing unit reads the printing condition setting script stored in the external storage device, and processes the printing condition setting script based on the condition information to set a printing condition. The controlling unit controls the printing unit based on the printing condition.

Another aspect of the present invention provides a computer readable product containing a program executed by an image-forming device. The image-forming device includes a connecting unit electrically connectable to an external storage device storing a printing condition setting script, a printing unit that prints on a recording medium, an inputting unit in which a user inputs printing condition information, and a printing unit controlling unit that controls the printing unit based on the printing condition, the computer readable product instructing the image-forming device to implement. The computer readable product includes a reading process, processing process and a controlling process. The reading process reads the printing condition setting script stored in the external storage device. The processing process processes the printing condition setting script based on the condition information to set a printing condition. The controlling process controls the printing unit based on the printing condition.

### BRIEF DESCRIPTION OF THE DRAWINGS

In the drawings:

FIG. 1 is a block diagram illustrating a conventional printing system;

FIG. 2 is a block diagram showing the structure of a control panel employed in the conventional printing system;

FIG. 3 is an explanatory diagram showing a data tree of messages displayed on an LCD in the conventional printing system;

FIG. 4 is a flowchart illustrating steps in a settings/functions confirmation printing process executed with the conventional printing system;

FIG. 5 is a perspective view showing a printing system according to a first embodiment of the present invention;

FIG. 6 is a block diagram showing an electrical structure of the printing system;

FIG. 7 is a front view of a control panel provided on a printer in the printing system;

FIG. 8 is an explanatory diagram illustrating three printing modes;

FIG. 9A is an explanatory diagram showing data to be printed that is stored on a CompactFlash card;

FIG. 9B is an explanatory diagram showing lines of a program stored on the CompactFlash card;

FIG. 10 is an explanatory diagram illustrating various threads stored on the printer;

FIG. 11 is a flowchart illustrating steps in a panel process and CompactFlash card monitoring thread;

FIG. 12 is a flowchart illustrating steps in an SIP process;

FIG. 13 is an explanatory diagram showing content displayed on an LCD in the control panel of the printer;

FIG. 14A is a flowchart illustrating steps in subroutines for processing a command called from FIG. 12;

FIG. 14B is a flowchart illustrating steps in subroutines for processing a statement called from FIG. 12;

FIG. 15A is a flowchart illustrating steps in subroutines “DISP” called from FIG. 12;

FIG. 15B is a flowchart illustrating steps in subroutines “CD” called from FIG. 12;

FIG. 15C is a flowchart illustrating steps in subroutines “IF STATEMENT” called from FIG. 12;

FIG. 15D is a flowchart illustrating steps in subroutines “ENUM COMMAND” called from FIG. 12;

FIG. 15E is a flowchart illustrating steps in subroutines “KEYINPUT” called from FIG. 12;

FIG. 16A is an explanatory diagram showing another example of data to be printed that is stored on a CompactFlash card;

FIG. 16B is an explanatory diagram showing another example of lines of a program stored on the CompactFlash card;

FIG. 17 is a flowchart illustrating steps in a subroutine according to another example;

FIG. 18 is an explanatory diagram showing content displayed on the LCD according to another example;

FIG. 19A shows lines in another program;

FIG. 19B is a flowchart illustrating steps in a subroutine executed in the program of FIG. 19A; and

FIG. 20 is a flowchart illustrating steps in another subroutine.

### DETAILED DESCRIPTION OF THE PREFERRED EMBODIMENTS

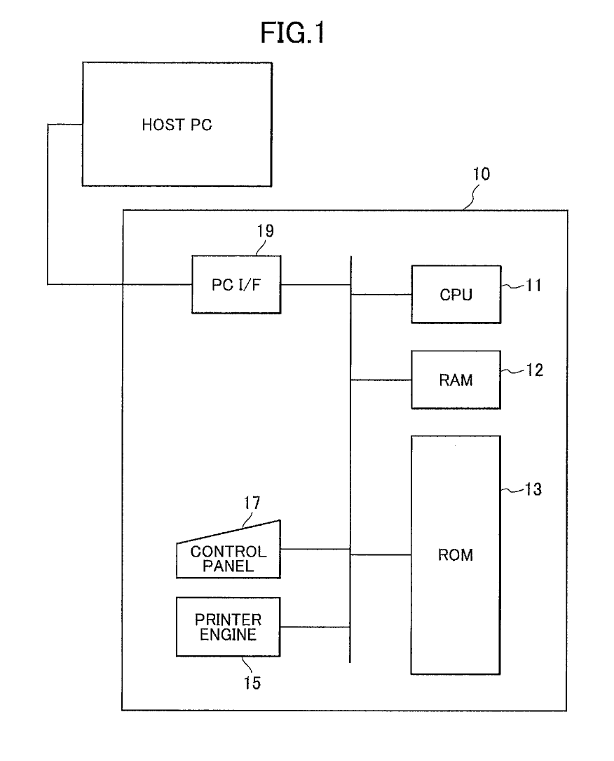

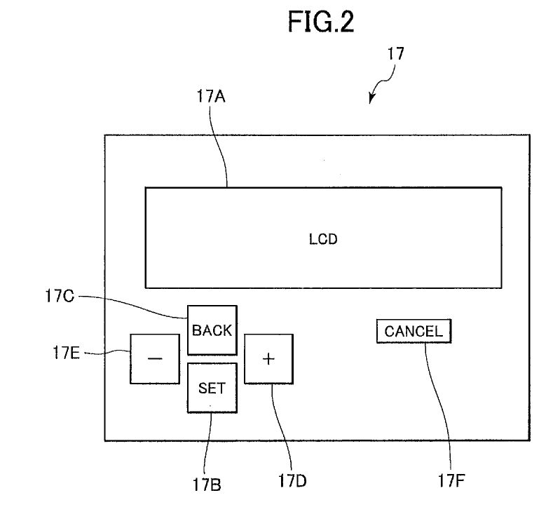

A printing system according to a first embodiment of the present invention will be described with reference to FIGS. 1 through 11.

<Overall Structure of the Printing System>

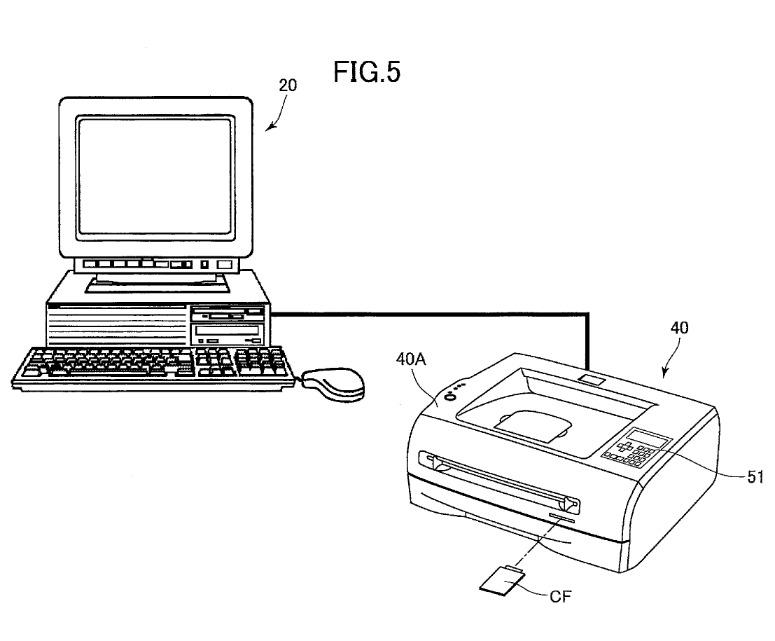

FIG. 5 is a perspective view showing the overall printing system. The printing system is configured of a host computer 20 and a printer 40 that are connected via a communication interface and are capable of communicating with each other bidirectionally.

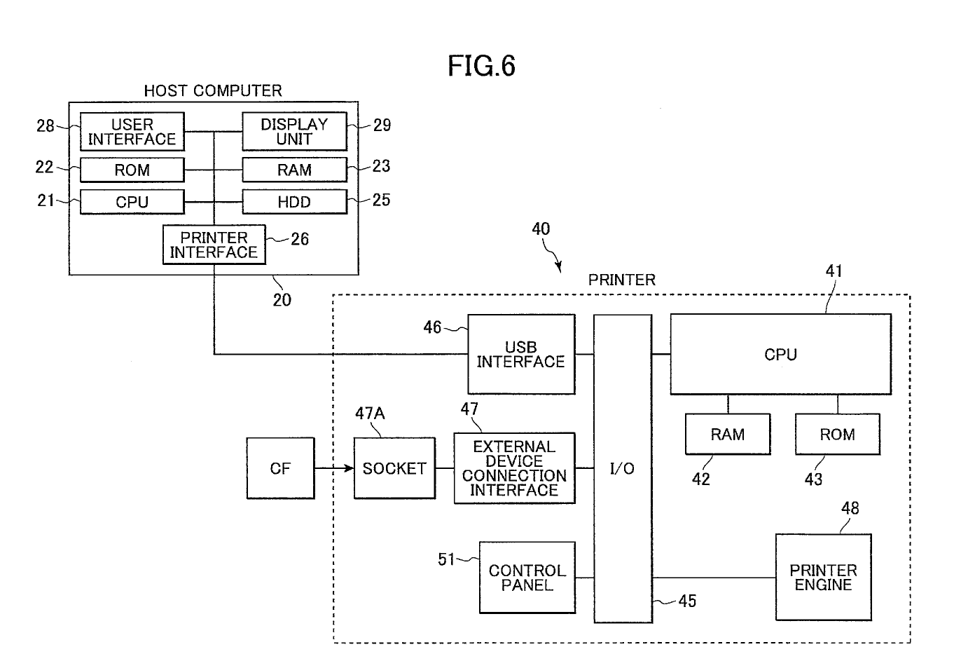

FIG. 6 is a block diagram showing the electrical structure of the printing system. As shown in FIG. 6, the host computer 20 includes a CPU 21, a ROM 22, a RAM 23, a hard disk drive (HDD) 25, a printer interface 26, a display unit 29, and a user interface 28 including a mouse, keyboard, and the like.

The hard disk drive 25 stores application programs such as a word processing program (hereinafter referred to as “application”), a printer driver, an operating system (OS), and the like. The applications are loaded into a prescribed area of the RAM 23 and are executed by the CPU 21. The applications can be used to create documents for printing by performing input operations via the user interface 28.

The printer driver includes a conversion program for converting printing instructions to a printer language. When the printer drive receives a print command through the OS, the printer driver performs a developing process to convert print data created with the application into page description language (PDL) data. The PDL data generated by the printer driver is transferred to the printer 40 via the printer interface 26.

The printer 40 includes a CPU 41, a RAM 42, a ROM 43, an input/output (I/O) device 45, a USB interface 46 for receiving PDL data outputted from the host computer 20, an external device connection interface 47, a control panel 51, and a printer engine 48. The CPU 41, USB interface 46, external device connection interface 47, control panel 51, and printer engine 48 are electrically connected to the I/O device 45. The user can modify settings for the printer 40 through operations on the control panel 51 or can execute printing operations in a second or third printing mode described later.

A CompactFlash (registered trademark; “CF” in the drawings) card serving as an auxiliary storage device can be inserted into a socket 47A to be electrically connect to the external device connection interface 47. The CompactFlash card is a memory card configured of flash memory for storing scripts used to set printing conditions, along with print data, as will be described in greater detail below.

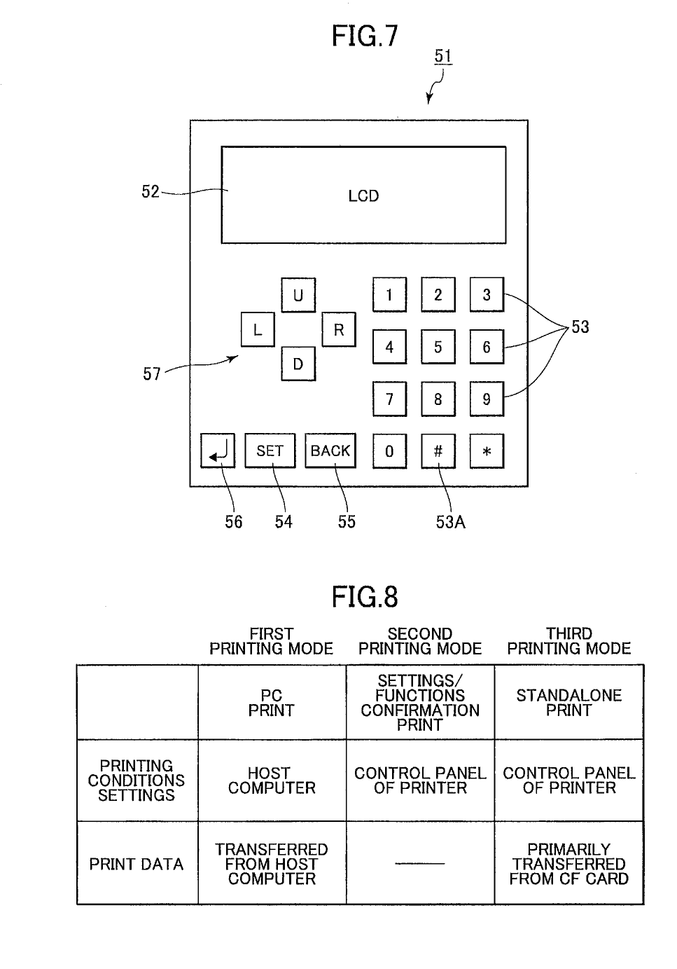

As shown in FIG. 5, the printer 40 has a casing 40A, and the control panel 51 is provided on the top surface of the casing 40A on one side thereof. As shown in FIG. 7, the control panel 51 is configured of a liquid crystal display (LCD) unit 52, a ten-key numeric keypad 53, a SET key 54, a BACK key 55, a return key 56, and various movement keys 57.

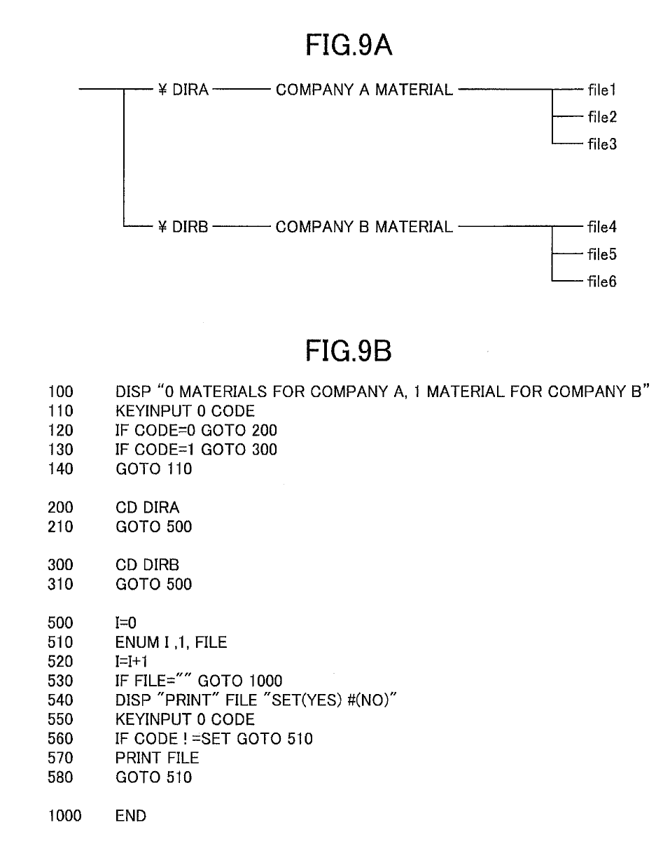

The printer 40 is configured to print in three modes shown in FIG. 8. The first printing mode is a PC print mode in which the host computer 20 and the printer 40 are connected to each other with a communication interface, such as USB or parallel interface, to allow bidirectional communications to be performed therebetween. In the PC print mode, the host computer 20 sets the printing conditions, and transmits the print command and print data. This is the most commonly used printing mode.

The second and third printing modes are performed autonomously on the printer 40 end without receiving a print command from the host computer 20. The second printing mode is a settings/functions confirmation print mode, best known by a test print mode, for verifying whether the printer 40 is functioning properly. The third printing mode is a standalone print mode in which the printer 40 reads data stored on a CompactFlash card and performs a printing operation based on this data.

Next, the overall standalone print mode will be described in brief. A description of the settings/functions confirmation print mode (including operations to modify print settings) will be included in the middle of this description.

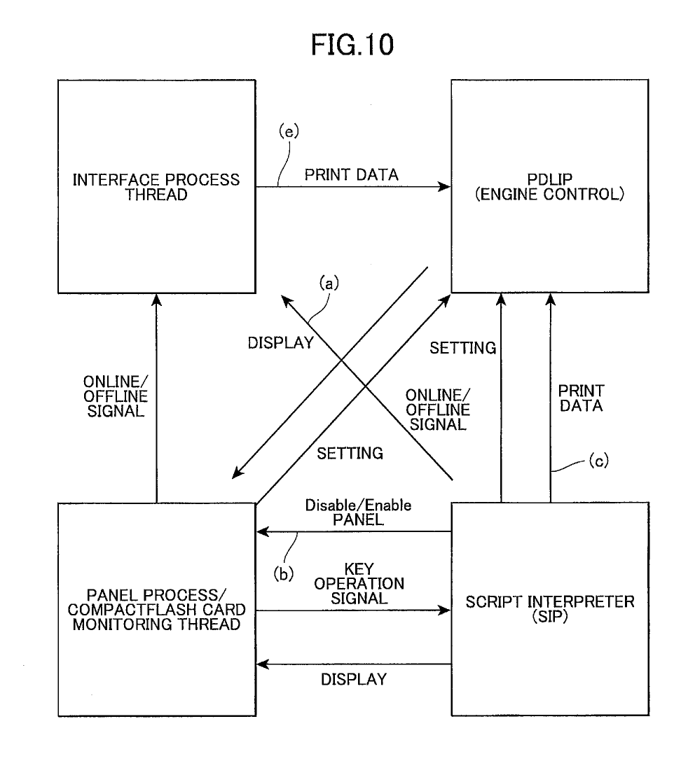

First, the data written to a CompactFlash card will be described. There are two types of data written to a CompactFlash card. The first type of data is print data that is the object of a printing operation. As shown in the example of FIG. 9A, the print data includes three document files (files 1-3) related to Company A, and three document files (files 4-6) related to Company B. Document files for each company are stored in different directories.

The second type of data written to the CompactFlash card is a printing conditions setting script, that is, a simple program for setting printing conditions (hereinafter referred to as “script 1”). Script 1 is written by the user. FIG. 9B shows lines of a sample program. The program is configured of nineteen lines having line numbers 100-1000.

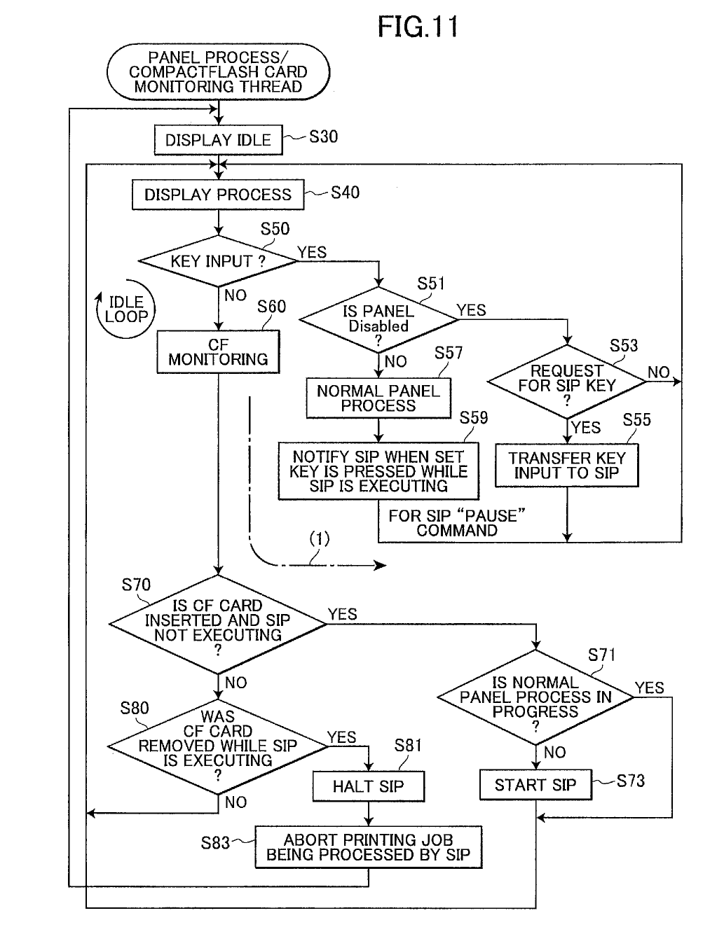

Next, a control program that the CPU 41 executes to perform printing operations in each mode will be described with reference to FIG. 10.

The ROM 43 of the printer 40 stores a plurality of programs, including an interface process thread, a panel process/CompactFlash card monitoring thread, a script interpreter thread (SIP), a PDL interpreter thread (PDLIP), and a confirmation printing process thread (not shown).

The interface process thread controls the online/offline state of a port provided in the I/O device 45 to which the USB interface 46 is connected (hereinafter referred to as the “specified port”) in order to control the ability of the host computer 20 to access the printer 40 via this specified port.

The SIP reads the printing conditions setting script stored on the CompactFlash card one line at a time, and interprets and executes each line of script in order to set the printing conditions for a standalone printing.

The panel process/CompactFlash card monitoring thread processes key input and monitors the socket 47A for insertion of a CompactFlash card. The process for key input involves detecting key input on the control panel 51 and setting the destination for allocating the key input. As a specific example, printing conditions are set through the control panel 51 in both the second and third printing modes, as shown in FIG. 8. Hence, when key input is received through the control panel 51, the panel process/CompactFlash card monitoring thread determines whether to transfer the input to the second printing mode (confirmation printing process thread) or the third printing mode (SIP thread) as described later.

The PDLIP converts the received print data (PDL data) into raster data and controls the printer engine 48 based on the specified printing conditions. Each of these threads is loaded into the RAM 42 at the beginning of the process.

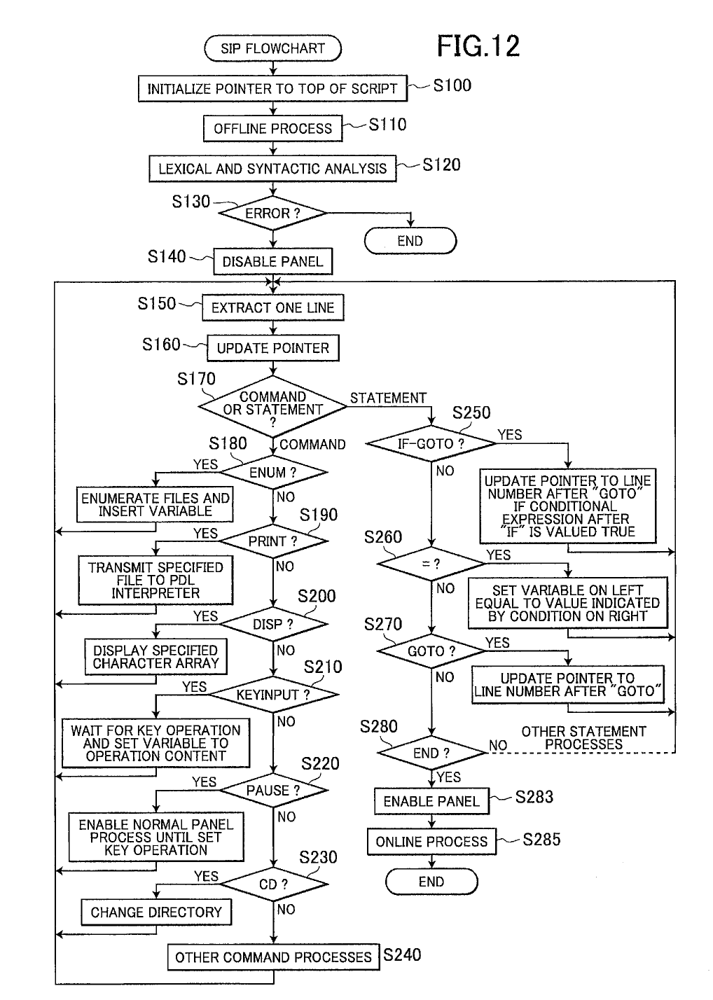

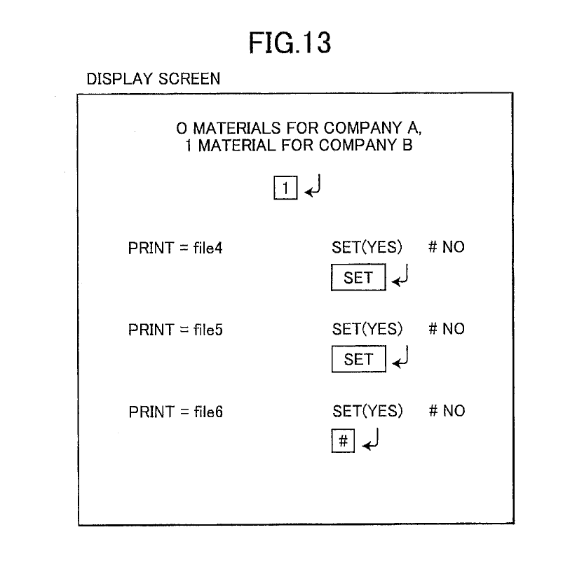

Next, a more detailed process of reading each thread and executing the thread with the CPU 41 will be described. FIG. 11 is a flowchart illustrating steps in the panel process/CompactFlash card monitoring thread. FIG. 12 is a flowchart illustrating steps in the SIP thread.

If a CompactFlash card has not been inserted, and no key input from the user has been detected, then the CPU 41 will determine “NO” in steps S50, S70, and S80 of FIG. 11. Accordingly, the CPU 41 will sequentially repeat these steps in the idle loop S40→S50→S60→S70→S80→S40.

While the CPU 41 is repeating processes in this idle loop (hereinafter referred to as an “idle state”), the message “Waiting for input” or the like is displayed on the LCD unit 52, for example. In this idle state, the user can perform operations to modify settings of the printer 40, and the CPU 41 can receive print data from the host computer 20 and print this data.

During this idle state, the printer 40 can also receive key input and the insertion of a CompactFlash card. If the user performs key input on the control panel 51, for example, the CPU 41 temporarily exits the idle loop to perform the corresponding process and subsequently returns to the idle loop. The same is true when a CompactFlash card is inserted. Hence, both a print settings confirmation print mode and a standalone print mode can be selectively performed during an idle loop through key input or the insertion of a CompactFlash card.

Specifically, if the user operates keys on the control panel 51 for modifying settings of the printer 40 or for executing a confirmation print (S50:YES), then in S51 the CPU 41 determines whether the panel process is in a disabled state that is set in the process of S140 described later. It is set in the present embodiment that when the printer 40 has entered an idle state at the beginning of this process, the printer is not in a panel disabled state (S51:NO). Thus, the CPU 41 advances to S57. The process of S51 for determining whether the panel process has been disabled will be described later.

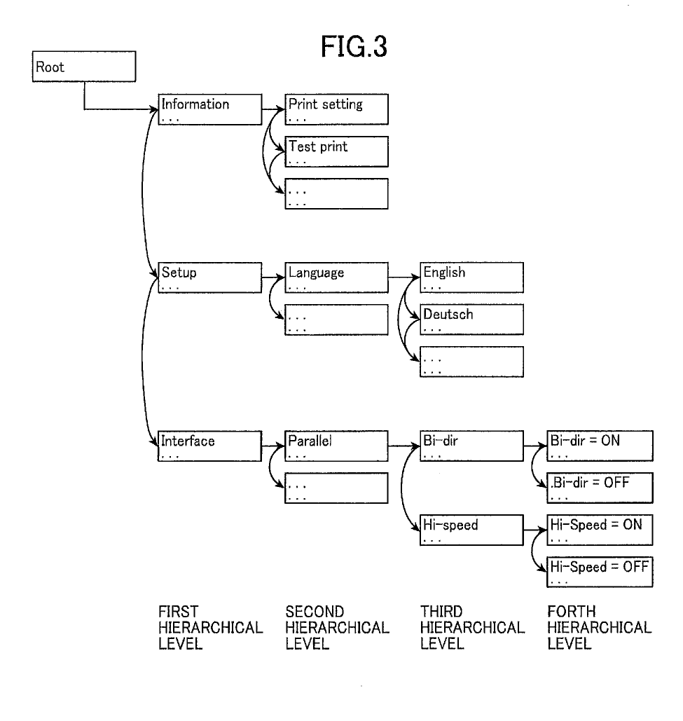

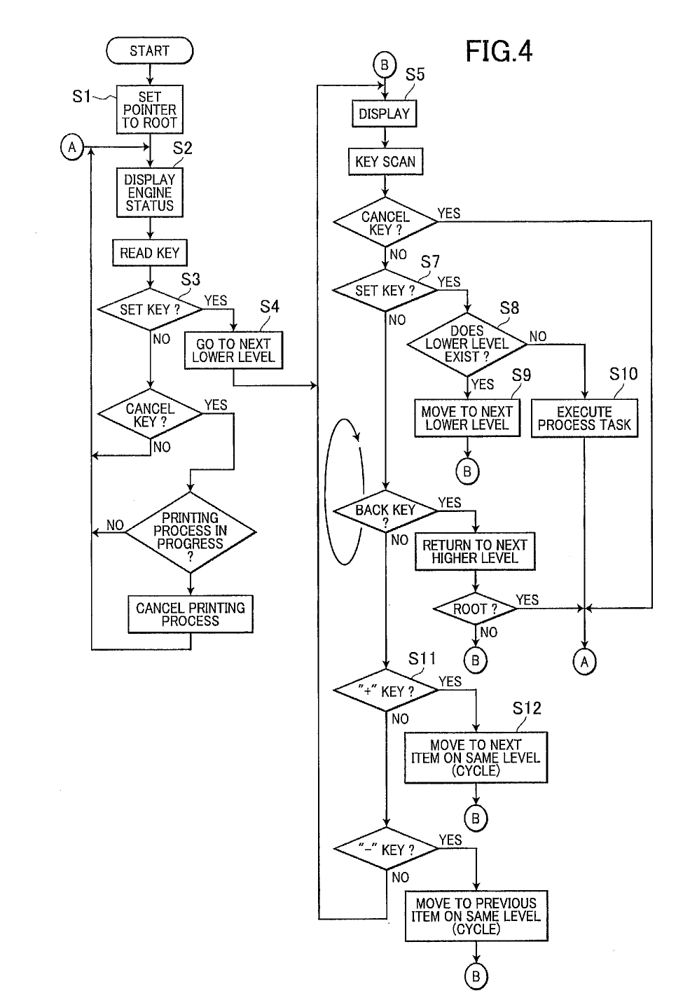

In S57 the CPU 41 performs a normal panel process for assigning key input from the control panel 51 to programs for modifying the settings of the printer 40 or executing a confirmation print (confirmation printing process thread). Accordingly, the CPU 41 performs a process conforming to the confirmation printing process thread. The content of this process is essentially identical to the process described in the prior art (see FIGS. 3 and 4) in which directory operations are performed on a hierarchical menu.

After completing the normal panel process in S57, the CPU 41 returns to S40 and modifies the display in the LCD unit 52 to correspond with the key operation. When printing conditions are set or modified through a plurality of key operations, the CPU 41 performs the normal panel process of S57 after each operation (S50: YES, S51: NO). The process in S59 will be described later.

On the other hand, when the user inserts a CompactFlash card into the printer 40 while the CPU 41 is in the idle loop in order to execute a standalone print, the CPU 41 detects that a CompactFlash card has been inserted in the printer 40 in the CompactFlash card monitoring process of S60. If the SIP is not executing at this time (S70: YES), the CPU 41 temporarily exits the idle loop in the panel process/CompactFlash card monitoring thread along a path (1) shown in FIG. 11.

A process for starting the SIP is performed along this path (1). However, before starting the SIP, the CPU 41 determines in S71 whether a normal panel process is in progress. When the normal panel process in S57 requires a plurality of key operations before completion, as in the case of S51, the process in S71 prevents the SIP from being started and interfering with the normal panel process before all key operations have been completed.

Hence, while the normal panel process is in progress, the CPU 41 repeatedly loops through steps S40, S50, S60, S70, and S71. In this way, the SIP is not started before the normal panel process has completed.

Once the normal panel process has completed (S71: NO), the CPU 41 starts the SIP in S73.

Hereafter, the process according to the panel process/CompactFlash card monitoring thread and the process according to the SIP are executed in parallel. After the SIP is started, the determination in S70 will be “NO” thereafter. Therefore, the panel process/CompactFlash card monitoring thread will return to the previous idle loop to wait for input.

The SIP process is shown in FIG. 12 and can be broadly divided into an “initialization/mode setting process,” and a “script interpreting process” for setting printing conditions to perform a standalone print and transmitting the data to the PDLIP.

a. Initialization/Mode Setting Process

The initialization/mode setting process includes the processes in steps S100-S140. In S100 the CPU 41 sets a pointer to point at the top line in script 1 read from the CompactFlash card (initialization).

In S110 the CPU 41 performs an offline process for preventing the host computer 20 from transmitting a print command to the printer 40 via the USB interface 46 along the path (e) indicated in FIG. 10. More specifically, the CPU 41 transmits an offline signal (a signal transmitted along the path (a) indicated in FIG. 10) from the SIP to the interface process thread.

Upon receiving this signal, the interface process thread closes the specified port provided on the I/O device 45 to which the USB interface 46 is connected according to the protocol, thereby interrupting communications with the host computer 20.

In S120 the CPU 41 analyzes the script 1 read from the CompactFlash card both lexically and syntactically. In S130 the CPU 41 determines whether errors exist. If no lexical or syntactical errors exist (S130: NO), the CPU 41 advances to S140.

In S140 the CPU 41 sets the panel process to a disabled state corresponding to the path (b) in FIG. 10. After the panel process has been disabled, the panel process/CompactFlash card monitoring thread will not advance to S57 in FIG. 11, even if the user performs a key operation, because the CPU 41 will determine that the panel is disabled in S51. Moreover, after the CPU 41 determines that the panel process is disabled (S51: YES), in S53 the CPU 41 will determine that there is no SIP request (S53: NO) except the user performs key input described later, and will return to S40. Hence, once the panel process has been disabled, normal key input for the panel process is ignored, preventing the normal panel process from being executed until the process is again enabled. Therefore, by disabling the panel process, it is possible to dissociate key input on the control panel 51 from the normal panel process.

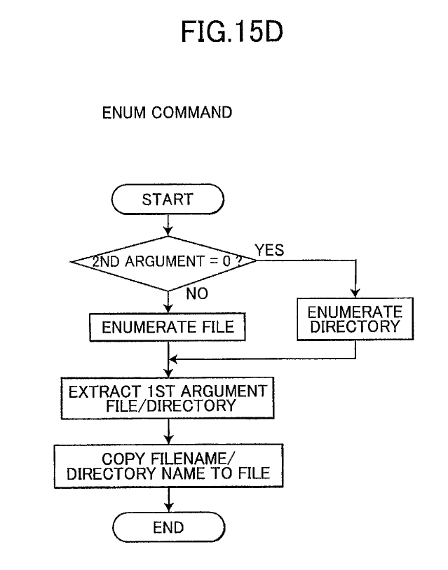

As described above, since communications are interrupted by closing the specified port of the I/O device 45 in S110 and further since the key input on the control panel 51 is dissociated from the normal panel process in S140, only print commands sent to the PDLIP and, hence, to the printer engine 48 through the SIP are valid while the SIP is executing, while printing in other modes is prohibited (mode setting). Note that even if the SIP thread is performed, the key input by the user is valid when a key input process (shown in FIG. 15E) and the like described later are called (S53: YES). Thus, in S55 the CPU 41 transfers the key input to the SIP instead of ignoring the input.

b. Script Interpreting Process

After the process up to S140 is completed, the CPU 41 performs the script interpretation/implementation process in the following steps for setting printing conditions. In S150 the CPU 41 reads each program line corresponding to the pointer. In S160 the CPU 41 moves the pointer to the next line.

After updating the pointer, in S170 the CPU 41 determines whether the line of data read in S150 is a simple command line for the LCD unit 52 or other hardware resource, or a statement for controlling the process flow for executing the program list. If the line of data is a command line, then in S180-S240 the CPU 41 determines the type of command and performs a process corresponding to that command.

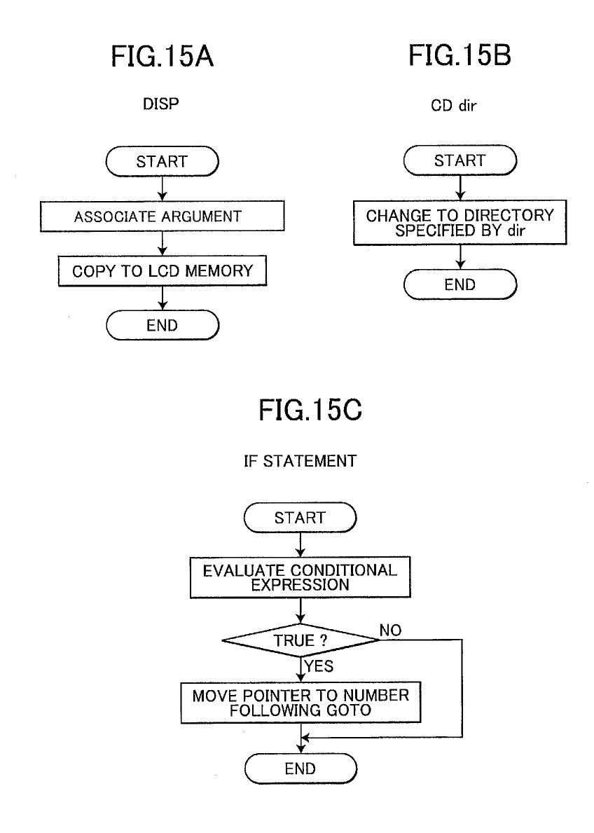

On the other hand, when the line of data is a statement, then in S250-S270 the CPU 41 determines the type of statement and performs a process corresponding to that statement. Processes corresponding to each command and each statement are executed as subroutines shown in FIGS. 14 and 15. When the CPU 41 makes a YES determination in one of the steps S180-S270, the CPU 41 executes the corresponding subroutine at that time. For example, if the command in the program list is “DISP” (S200: YES), then the CPU 41 reads the “DISP” subroutine and executes the process.

Next, each command will be described briefly. “ENUM” is a process for enumerating a file and defining a variable. “PRINT” is a process for transmitting the specified file and input to the PDLIP. “DISP” is a process for displaying a specified character array. “KEYINPUT” is a process for waiting for a key operation and assigning the content of the operation to the variable when the key operation is performed. “PAUSE” is a process for enabling the normal panel process until the SET key 54 is operated. “CD” is a process for changing the current directory in CompactFlash file system.

Next, the content of each statement will be briefly described. “IF-GOTO” is a process for evaluating a conditional expression following the “IF” and for changing the pointer to the liner number following “GOTO” if the conditional expression is true. “=” is a process for assigning the value indicated in the condition on the right side of “=” to the variable on the left side of “=”. “GOTO” is a process for changing the pointer to the line number following “GOTO”.

After the process corresponding to the command or statement has been completed, the CPU 41 returns to S150. At this time, the pointer has been updated (in the process of S160 described above). Accordingly, the CPU 41 reads the next instruction and performs the process corresponding to that instruction. By reading and executing each instruction in this way, the CPU 41 performs the script interpretation/implementation process.

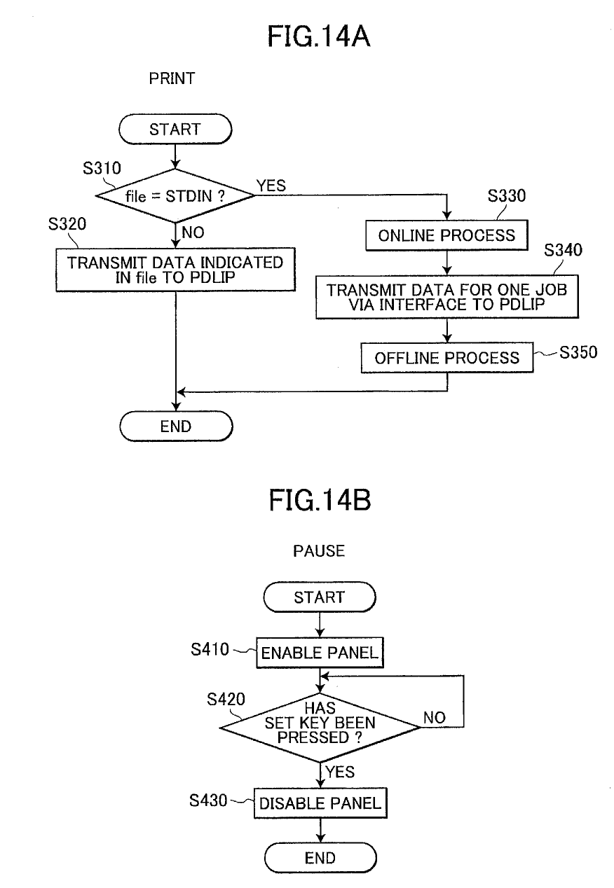

Next, detailed steps in the process for interpreting and implementing the script 1 will be described. As shown in FIG. 9B, the syntax of the top line in the script 1 (line 100) is the command “DISP”. Therefore, after determining that the syntax is a command in S170, the CPU 41 determines that the command is “DISP” (S200: YES) and executes a process for displaying a specified character array. In this example, the character array “0 materials for Company A, 1 material for Company B” is displayed on the LCD unit 52 in the control panel 51, as shown in FIG. 13.

After the process corresponding to the syntax in line 100 is completed, the CPU 41 returns to S150. Since the pointer was updated in the previous process of S160, the CPU 41 extracts the next line, that is, the syntax in line 110. Subsequently, the CPU 41 updates the pointer again in S160.

Since the syntax in line 110 is the command “KEYINPUT,” the CPU 41 determines that the syntax is a command in S170 and determines that the command is “KEYINPUT” (S210: YES). As a result, the SIP process is placed in a wait state to wait for input from the user.

If the user that views the LCD unit 52 presses the numeral “1” on the ten-key numeric keypad 53 of the control panel 51 to print out materials for the Company B, this key operation is detected in the panel process/CompactFlash card monitoring thread (S50 of FIG. 11: YES).

Since the panel process has been disabled by the SIP initialization/mode setting process (S140 of FIG. 12), the step of FIG. 11 goes to S53 (S51: YES). Then, since the SIP process is in a wait state for key input (S210: YES), the step of FIG. 11 goes to S55 (S53: YES). In S55 the CPU 41 performs a process to transfer the key input to the SIP. Hereafter, the panel process/CompactFlash card monitoring thread returns to the idle loop.

The wait state of the SIP is canceled upon receiving key input. When the SIP process resumes, a key code for the key input is assigned to a variable CODE, as indicated in the script content (See FIG. 15E). Subsequently, the CPU 41 reads the syntax of line 120 in S150. After reading this syntax, in S160 the CPU 41 updates the pointer and in S170 branches to the side for processing statements since the syntax of line 120 is a statement (“IF-GOTO”).

Since the syntax of line 120 is the control statement “IF-GOTO” (S250: YES), the CPU 41 evaluates the conditional expression (CODE=0) Since the user input inputs “1” in line 100, the determination is “false.” Hence, the CPU 41 ends the process for the control statement “IF-GOTO” and returns to S150.

Next, in S150 the CPU 41 reads line 130 and subsequently updates the pointer in S160. Since the syntax of line 130 is again an “IF-GOTO” control statement (S250: YES), the CPU 41 evaluates the conditional expression (CODE=1). This time the expression is determined to be “true.” Hence, the CPU 41 changes the pointer to line number 300.

The CPU 41 returns to S150 and reads the syntax for line 300. Since the syntax for line 300 is the command statement “CD” (S230: YES), the CPU 41 changes the current directory to “DIRB.” After completing the process in S230, the CPU 41 returns to S150 and reads the syntax for line 310. Since the syntax in line 310 is the control statement “GOTO” (S270: YES), the CPU 41 updates the pointer to line 500.

Hereafter, the syntax for each line is read and processed according to the same procedure described above. In line 510, I-th filename is extracted with the command “ENUM”. As shown in FIG. 15D, “ENUM” is such a command that extracts the I-th filename stored in the current directory when the first argument is “1”, and extracts the I-th directory name stored in the current directory and sets to variable “FILE” when the first argument is “0”. The process corresponding to the syntax in line number 540 displays the filename (file 4) of the first file in the files stored in DIRB shown in FIG. 13 on the LCD unit 52. Subsequently, the SIP enters a wait state to wait for key input. When the user performs key input, this input is detected on the panel process/CompactFlash card monitoring thread end and is subsequently transferred to the SIP.

Accordingly, the SIP process resumes and the CPU 41 determines printing of the file corresponding to the user's selection (key input). In other words, when the user pushes the SET key 54, the CPU 41 will reach a “false” determination for the conditional expression in line 560. Hence, the CPU 41 performs the process in line 570 (executes a print) by transferring print data in the displayed file to the PDLIP. The displayed file is printed by the PDLIP.

In the process for line 580 the CPU 41 changes the pointer to line 510 and subsequently repeats the process in sequence from line 510. At this time, the value for a variable I has been updated in lines 510 and 520. Therefore, the filename (file 5) for the second file in the directory is displayed on the LCD unit 52, enabling the user to select whether to print this file.

The user can press a “#” key 53A on the control panel 51 to indicate a desire not to print. In this case, the CPU 41 reaches a “true” determination for the conditional expression in line 560. Therefore, the CPU 41 changes the pointer to line number 510 without executing the process in line 570 to transmit print data in the displayed file to the PDLIP.

By repeating this series of steps, the user can select whether or not to print each of the files. When there are no more files to display, the CPU 41 reaches a “true” determination for the conditional expression (FILE=″″) in line 530 and changes the pointer to line number 1000. Consequently, in FIG. 12 the CPU 41 determines that there are no more statements to process (S280: YES), and ends the script interpretation process with SIP. FIG. 13 shows an example in which the user has selected printing conditions for printing only files 4 and 5 and not file 6.

In the process described above, print data in the user-selected files is transmitted to the PDLIP along the path (c) in FIG. 10. The PDLIP first converts the print data to raster data and subsequently drives the printer engine 48 based on this data to print the print data for files 4 and 5.

Next, a post-process performed after the standalone printing operation (a process for halting the SIP) will be described.

When the process in line number 1000 is performed (S280 of FIG. 12: YES), the CPU 41 performs a process to return the control state of the printer 40 to the state prior to executing the SIP. Specifically, in S283 the CPU 41 returns the panel process to its previous enabled state. Therefore, all subsequent key input that the user performs on the control panel 51 is subjected to the normal panel process (S51: YES).

In S285 of FIG. 12, the CPU 41 performs an online process in which an online signal is transmitted from the SIP to the interface process thread along the path (a) indicated in FIG. 10. This signal opens the specified port of the I/O device 45, enabling the host computer 20 to transmit data to the printer 40 via the specified port. Subsequently, the SIP operation is halted.

If the CompactFlash card is removed while the SIP is executing in the preferred embodiment, the SIP is forcibly halted. Specifically, the CPU 41 determines that the card has been removed while the SIP is still executing (S80: YES) and in S81 forcibly ends the operation of the SIP. If a job is currently being processed when the SIP is forcibly ended, in S83 a process is performed to abort the job.

In the preferred embodiment described above, the printer 40 includes a script interpreter (SIP). Moreover, the SIP is provided with a process for interpreting control statements with conditional branching, such as “IF-GOTO” (specifically, “IF-GOTO” and a subroutine for executing “IF-GOTO”).

The printing conditions setting script according to the preferred embodiment is capable of not only controlling the printer 40 but also using as a menu for allowing the user to select desired printing conditions from a plurality of selective options.

Therefore, the printer 40 of the preferred embodiment can provide a rich variation of printing conditions through a simple structure, that is, through one printing conditions setting script. Further, the conditions selected by the user in the preferred embodiment are sequentially displayed on the LCD unit 52. With this configuration, the user can view the displayed conditions and select desired printing conditions, thereby facilitating the condition setting operation.

Since the printing system of the preferred embodiment can print in a plurality of modes, the printing system needs to be configured so that incorrect printing operations are not performed when the printer 40 is instructed to operate in a first mode during operating in a second mode, e.g., when the standalone print mode is instructed by insertion of the CompactFlash card during printing with the PC printing mode, or when a plurality of print commands or a plurality of pieces of print data is simultaneously sent to the printer engine 48 of the printer 40.

In the present embodiment, the SIP cannot start until the normal panel process in the panel process/CompactFlash card monitoring thread of the preferred embodiment has completed (S71). Moreover, once the SIP has started, the specified port of the I/O device 45 is closed (S110 of FIG. 12) to interrupt communications with the host computer 20, and dissociating key input on the control panel 51 from the normal panel process (S140).

In this way, only a print command issued to the PDLIP and, hence, to the printer engine 48 through the SIP is valid when the SIP is executing, while other print commands are not performed.

Since the program for setting printing conditions in the preferred embodiment is implemented with an interpreter-type script language (simple language), operations from the insertion of a CompactFlash card to the printing operation are simplified. More specifically, if a programming language, such as the C language, that requires compiling were used, an object file must be generated from the source file prior to executing the program, requiring a special operation before printing can be performed. However, use of an interpreter language eliminates this operation.

Further, a wide variety of printing can be performed using the CompactFlash card to meet user-specified usage conditions. For example, print data can be acquired from the host computer 20 side, while printing conditions are set on the printer side. Therefore, the following process is provided in the preferred embodiment for meeting these requirements.

As shown in FIG. 14A, when executing the command “PRINT,” in S310 the CPU 41 determines whether the file to be printed is an STDIN (standard input from an interface). As described above, when the file to be printed has already been written to the CompactFlash card (S310: NO), the CPU 41 advances to 5320 and performs a process to transmit the specified file to the PDLIP. On the other hand, if the file is STDIN (S310: YES), then in S330 the CPU 41 performs the online process. As a result of this process, print data can be acquired from the host computer 20 via the specified port of the I/O device 45. In S340 the CPU 41 transmits the print data to the PDLIP via the interface process thread along the path (e) indicated in FIG. 10. In S350 the CPU 41 performs the offline process again.

Further, the commands subjected to processing in the SIP include a “PAUSE” command (S220 of FIG. 12), making it possible to temporarily interrupt the SIP to perform the normal panel process. When the “PAUSE” process is executed in S410 of FIG. 14B, the panel process is switched to an enabled state, enabling the normal panel process to be performed thereafter.

When the normal panel process is performed, various keys can be pressed. If the pressed key is not the SET key 54 (S420: NO), the panel process remains enabled. On the other hand, if the SET key 54 is pressed to set the process content (this assumes that the SET key 54 is not used other than for setting process content), the process content is set. At this time, since the SET key 54 has been pressed (S420: YES), in S430 the CPU 41 changes the panel process back to the disabled state.

The process in S59 of FIG. 11 is provided in the panel process/CompactFlash card monitoring thread in response to the “PAUSE” process on the SIP side. Specifically, if the SET key 54 is pressed during the “PAUSE” process, the SIP is notified of this key operation.

Next, a printing system according to a second embodiment of the present invention will be described. In the printing system according to the second embodiment, the printer 40 of the first embodiment is additionally provided with a sensor for detecting the insertion of a CompactFlash card (built into the CompactFlash socket 47A, for example) and includes a display function for displaying the printing conditions setting script.

When a CompactFlash card is inserted into the printer 40 in the second embodiment, the CompactFlash card sensor detects the card and transmits a detection signal to the CPU 41. In response, the CPU 41 issues a data read command through the external device connection interface 47 in order to read data from the CompactFlash card.

In this way, the printing system of the second embodiment eliminates the need for a special operation to initiate reading of the printing conditions setting script. Accordingly, fewer operations are required to perform a print, making the printing system more user-friendly.

The ROM 43 also stores an editing software program for editing the printing conditions setting script. When the editing program is executed, lines of a program are displayed on the LCD unit 52 (such as the script 1 being displayed from the first line), enabling a user to edit the script.

Normally, programs such as scripts are created on a data processing device, such as a personal computer. As a result, the user cannot confirm the content of the program on the printer 40 end. However, in the printing system according to the second embodiment, the printing conditions setting script is displayed on the LCD unit 52 of the printer 40, as described above, enabling the user to edit this script with the editing program when needed. Hence, the user can view the script on the printer end and can rewrite the script to a desired content if the script does not meet the user's needs.

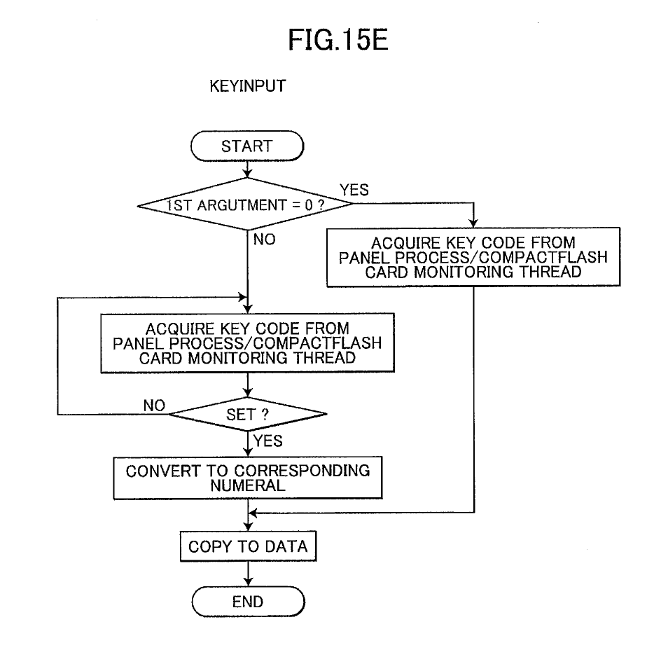

Next, another example for using the printing system of the preferred embodiments will be described with reference to FIGS. 16 through 18. In this example, a CompactFlash card storing print data and a printing conditions setting script different from those described in the first embodiment is inserted in the printer 40.

First, the print data written in the CompactFlash card will be described. The data in the CompactFlash card includes two directories: a MACRO directory and a DATE directory. The MACRO directory includes three macro files containing images of a logo (logos 1-3), and the DATE directory includes two document files (dates 1 and 2). Here, logo signifies an image of a logo mark.

Next, the printing conditions setting script (hereinafter simply referred to as a “script 2”) will be described. As shown in FIG. 16B, the script 2 includes eighteen lines of syntax with line numbers 100-1000. The user is prompted to select one macro file (logo) from the files in the MACRO directory as the printing conditions and to attach and print the selected logo with the two document files in the DATE directory.

In line 140 of FIG. 16, the CPU 41 executes a process to display each logo image file provided in the MACRO directory. In the process of line 150, the CPU 41 waits for key input from the user. In line 170, the CPU 41 transmits the image file selected by the user to the PDLIP.

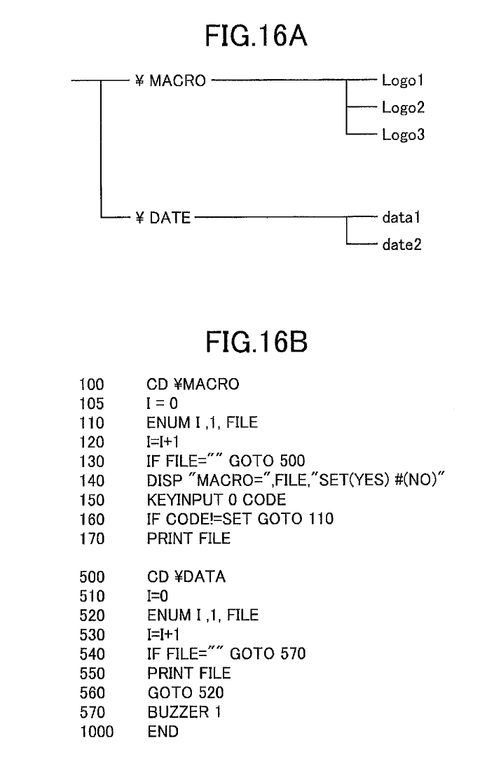

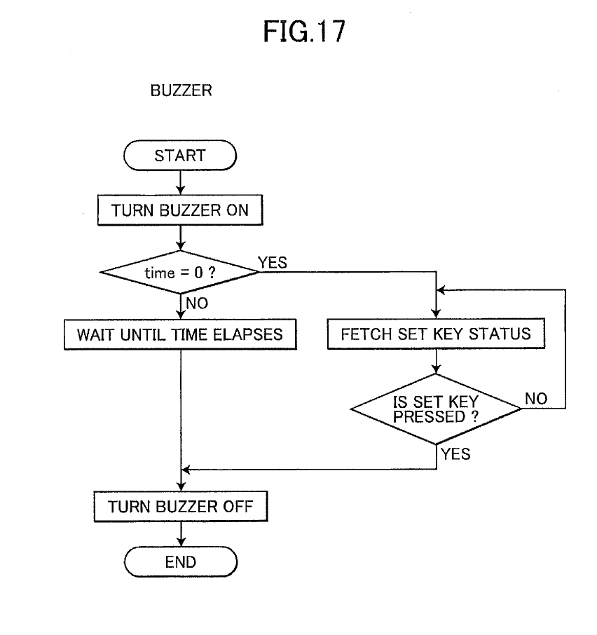

In line 550, data from each file in the DATE directory is transmitted to the PDLIP. In line 570 the CPU 41 performs a process to sound a buzzer for a prescribed interval to indicate the end of the printing operation. This process is shown in greater detail in the flowchart of FIG. 17. FIG. 18 shows the display content on the LCD unit 52 when the user has selected logo 2.

While the invention has been described in detail with reference to specific embodiments thereof, it would be apparent to those skilled in the art that many modifications and variations may be made therein without departing from the spirit of the invention, the scope of which is defined by the attached claims.

(1) In the first embodiment described above, a CompactFlash card is used as the auxiliary storage device. However, the auxiliary storage device may be a hard disk drive, for example, provided that the device can be detachably mounted in the printer and can store data.

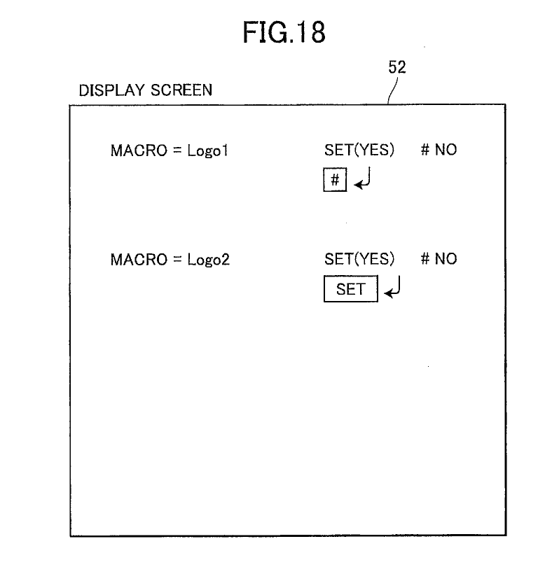

(2) While two examples were given above for the printing conditions setting script, the present invention is not limited to these sample scripts. For example, in the example shown in FIG. 19, the user is prompted to select a number of copies, and the printer is instructed to collate different files during the printing operation. In this example, files 1 and 2 are grouped together and the selected number of copies is outputted to separate trays.

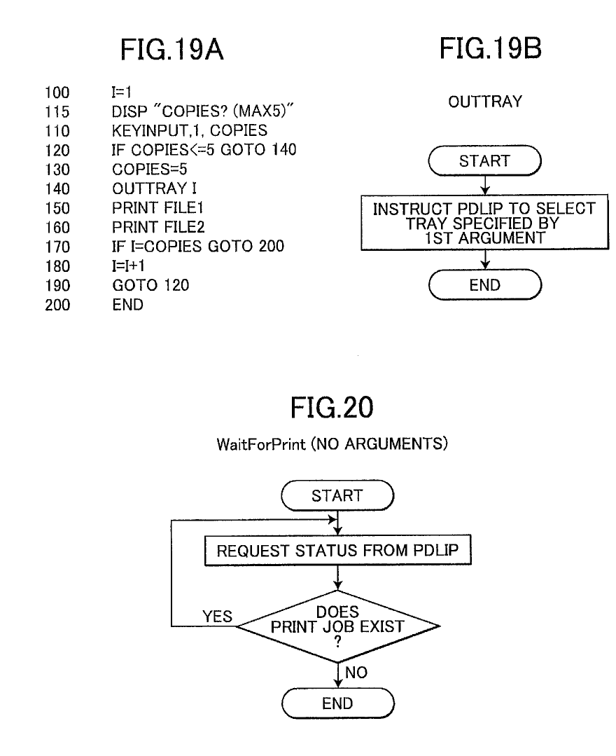

(3) Further, the subroutines are not limited to the examples shown in FIGS. 14 and 15 but may include other subroutines, such as the example WaitForPrint shown in FIG. 20. This subroutine can control the printer to execute the next printing process after the current printing process has completed.

(4) Further, the print data written in the CompactFlash card may be data for applications other than documents, such as image data created with a digital camera or other imaging device.

What is claimed is:

1. An image-forming device comprising:
a connecting unit electrically connectable to an external storage device storing a printing condition setting script;
a printing unit that prints a recording medium;
an inputting unit in which a user inputs printing condition information;
a script-processing unit that reads the printing condition setting script stored in the external storage device, and processes the printing condition setting script based on the condition information to set a printing condition; and
a controlling unit that controls the printing unit based on the printing condition.

2. The image-forming device according to claim 1, wherein the external storage device stores pieces of print data,
wherein the script-processing unit processes the printing condition setting script based on the condition information to select the print data as the printing condition.

3. The image-forming device according to claim 1, further comprising a displaying unit that displays the printing condition.

4. The image-forming device according to claim 3, wherein the displaying unit displays images indicating the printing condition setting script stored in the external storage device.

5. The image-forming device according to claim 1, wherein when another information different from the printing condition information is inputted to the inputting unit during the process for setting the printing condition, the script-processing unit processes the condition information and another information separately.

6. The image-forming device according to claim 5, further comprising a process start timing controlling unit that prevents the script-processing unit from beginning the process for setting the printing condition while a process for processing another information is performed.

7. The image-forming device according to claim 1, wherein the external storing unit is provided on a host device.

8. The image-forming device according to claim 1, further comprising a port through which data from a host device is transferred or received to the script-processing unit, the port being selectively opened and closed,
wherein the script-processing unit controls the port to close when performing the process for setting the printing condition, to prevent the data from being inputted from the host device to the script-processing unit.

9. The image-forming device according to claim 8, wherein the script-processing unit controls the port to open when the external storing unit is provided on a host device.

10. The image-forming device according to claim 1, wherein the script-processing unit begins reading the printing condition setting script upon detecting that the external storage device is connected to the connecting unit.

11. The image-forming device according to claim 1, further comprising a pausing unit that pauses the process for setting the printing condition when the user inputs a signal thereto to enable input of another information to the inputting unit while the pausing unit is operating.

12. The image-forming device according to claim 11, further comprising an ending unit that ends the pausing of the process for setting the printing condition when the user inputs a signal thereto.

13. A computer readable product containing a program executed by an image-forming device including a connecting unit electrically connectable to an external storage device storing a printing condition setting script, a printing unit that prints on a recording medium, an inputting unit in which an user inputs printing condition information, and a printing unit controlling unit that controls the printing unit based on the printing condition, the computer readable product instructing the image-forming device to implement:
reading the printing condition setting script stored in the external storage device;
processing the printing condition setting script based on the condition information to set a printing condition; and
controlling the printing unit based on the printing condition.
